(19) United States
(12) Patent Application Publication
(10) Pub. No.: US 2022/0353951 A1
(43) Pub. Date: Nov. 3, 2022

(54) COLLISION OF UE-REQUESTED PDU SESSION RELEASE PROCEDURE AND NETWORK-REQUESTED PDU SESSION RELEASE PROCEDURE

(71) Applicant: MEDIATEK INC., Hsin-Chu (TW)

(72) Inventors: Yuan-Chieh Lin, Hsin-Chu (TW); Chi-Hsien Chen, Hsin-Chu (TW)

(21) Appl. No.: 17/706,512

(22) Filed: Mar. 28, 2022

Related U.S. Application Data
(60) Provisional application No. 63/181,393, filed on Apr. 29, 2021.

(51) Int. Cl. H04W 76/38; H04W 76/36

(52) U.S. Cl. CPC H04W 76/38; H04W 76/36

(57) ABSTRACT

A method for handling a collision of a UE-requested MA PDU session release procedure and a network-requested MA PDU session release procedure is proposed. If the Access type IE is included in the PDU SESSION RELEASE COMMAND message, and the PDU session is an MA PDU session and having user-plane resources established on the access different from the access indicated in the Access type IE in the PDU SESSION RELEASE COMMAND message, then the UE proceeds with both the UE-requested PDU session release procedure and network-requested PDU session release procedure. Otherwise, the UE aborts the UE-requested PDU session release procedure and stops the timer T3582 and proceeds with the network-requested PDU session release procedure.

### CROSS REFERENCE TO RELATED APPLICATIONS

This application claims priority under 35 U.S.C. § 119 from U.S. Provisional Application No. 63/181,393, entitled “Collision of UE-requested PDU Session Release Procedure and Network-requested PDU Session Release Procedure”, filed on Apr. 29, 2021, the subject matter of which is incorporated herein by reference.

### TECHNICAL FIELD

The disclosed embodiments relate generally to wireless communication, and, more particularly, to method for handling collision of UE-requested multi-access (MA) PDU session release procedure and network-requested MA PDU session release procedure.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board, has decided to focus the future NGMN activities on defining the end-to-end requirements for 5G new radio (NR) systems.

In 5G/NR, a protocol data unit (PDU) session defines the association between the UE and the data network that provides a PDU connectivity service. The PDU session establishment is a parallel procedure of PDN connection (bearer) procedure in 4G/LTE. Each PDU session is identified by a PDU session ID (PSI), and may include multiple QoS flows and QoS rules. Each PDU session can be established via a 5G access network (e.g., 3GPP radio access network (RAN), or via a non-3GPP RAN). The network/UE can initiate different PDU session procedures, e.g., PDU session establishment, PDU session modification, and PDU session release, for managing PDU sessions.

Operators are seeking ways to balance data traffic between mobile networks and non-3GPP access in a way that is transparent to users and reduces mobile network congestion. In 5GS, UEs can be simultaneously connected to both 3GPP access and non 3GPP access (using 3GPP NAS signalling), thus the 5GS is able to take advantage of these multiple accesses to improve the user experience and optimize the traffic distribution across various accesses. Accordingly, 3GPP introduced Multi-Access (MA) PDU session in 5GS. An MA PDU session can be configured to use one 3GPP access network or one non-3GPP access network at a time, or simultaneously one 3GPP access network and one non-3GPP access network.

MA PDU sessions can be established over both 3GPP access and non-3GPP access simultaneously, or one at a time. Therefore, the user plane resources of an MA PDU session can be established on both accesses, or only on 3GPP or non-3GPP access. For established MA PDU sessions, the 5GS can initiate a PDU session release procedure to release one specific access type or both access types for the MA PDU session. However, when UE receives a PDU SESSION RELEASE COMMAND message from the network during a UE-requested MA PDU session release procedure for the same PDU session, different UE behaviors are desirable under different scenarios.

A solution is sought.

### SUMMARY

A method for handling a collision of a UE-requested MA PDU session release procedure and a network-requested MA PDU session release procedure is proposed. The collision is detected when the UE receives a PDU SESSION RELEASE COMMAND message with the PTI IE set to “No procedure transaction identity assigned” during a UE-requested PDU session release procedure, and the PDU session indicated in the PDU SESSION RELEASE COMMAND message is the same as the PDU session that the UE requests to release. If the Access type IE is included in the PDU SESSION RELEASE COMMAND message, and the PDU session is an MA PDU session and having user-plane resources established on the access different from the access indicated in the Access type IE in the PDU SESSION RELEASE COMMAND message, then the UE proceeds with both the UE-requested PDU session release procedure and network-requested PDU session release procedure. Otherwise, the UE aborts the UE-requested PDU session release procedure and stops the timer T3582 and proceeds with the network-requested PDU session release procedure.

In one embodiment, a UE maintains a multi-access protocol data unit (MA PDU) session in a 5G system (5GS). The MA PDU session has a PDU session ID (PSI). The UE transmits a PDU session release request message to the 5GS for a UE-requested PDU session release procedure for the MA PDU session. The PDU session release request message indicates the PSI and a UE-allocated procedure transaction ID (PTI) value. The UE receives a PDU session release command message from the 5GS for a network-requested PDU session release procedure for the MA PDU session. The UE detects a collision between the UE-requested PDU session release procedure and the network-requested PDU session procedures for the same MA PDU session. The UE proceeds with both the UE-requested PDU session release procedure and the network-requested PDU session release procedure upon satisfying a condition, otherwise aborts the UE-requested PDU session release procedure and proceeds with the network-requested PDU session release procedure.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G network supporting multi-access (MA) protocol data unit (PDU) session management and a method for handling collision of PDU session release procedures for an MA PDU session in accordance with one novel aspect.

FIG. 2 illustrates simplified block diagrams of a user equipment (UE) and a network entity in accordance with embodiments of the current invention.

FIG. 3 illustrates one embodiment of handling collision of PDU session release procedures for an MA PDU session in accordance with one novel aspect.

FIG. 4 illustrates another embodiment of handling collision of PDU session release procedures for an MA PDU session in accordance with one novel aspect.

FIG. 5 is a flow chart of a method of handling collision of PDU session release procedures for an MA PDU session in accordance with one novel aspect of the present invention.

### DETAILED DESCRIPTION

Reference will now be made in detail to some embodiments of the invention, examples of which are illustrated in the accompanying drawings.

FIG. 1 illustrates an exemplary 5G network 100 supporting multi-access (MA) protocol data unit (PDU) session management and a method for handling collision of MA PDU session release procedures in accordance with one novel aspect. 5G new radio (NR) network 100 includes a user equipment (UE) 101, a 3GPP access 102 (e.g., a 3GPP radio access network (RAN)), a non-3GPP access 103 (e.g., a non-3GPP RAN), an access and mobility management function (AMF) 110, a session management function (SMF) 111, an Non-3GPP interworking function (N3IWF) 112, a user plane function (UPF) 113, and a 5G core (5GC) data network 120. The AMF 110 communicates with the base stations in the 3GPP access 102, the SMF 111, and the UPF 113 for access and mobility management of wireless access devices in the 5G network 100. The SMF 111 is primarily responsible for interacting with the decoupled data plane, creating, updating and removing PDU sessions and managing session context with the UPF 113. The N3IWF 112 interfaces to 5G core network control plane functions, responsible for routing messages outside 5G RAN.

In Access Stratum (AS) layer, an RAN provides radio access for the UE 101 via a radio access technology (RAT). In Non-Access Stratum (NAS) layer, the AMF 110 and the SMF 111 communicate with RAN and 5GC for access and mobility management and PDU session management of wireless access devices in the 5G network 100. The 3GPP access 102 may include base stations (gNBs or eNBs) providing radio access for the UE 101 via various 3GPP RATs including 5G, 4G, and 3G/2G. The non-3GPP access 103 may include access points (APs) providing radio access for the UE 101 via non-3GPP RAT including WiFi. The UE 101 can obtain access to data network 120 through 3GPP access 102, AMF 110, SMF 111, and UPF 113. The UE 101 can obtain access to data network 120 through non-3GPP access 103, N3IWF 112, AMF 110, SMF 111, and UPF 113. The UE 101 may be equipped with a single radio frequency (RF) module or transceiver or multiple RF modules or transceivers for services via different RATs/CNs. In some examples, UE 101 may be a smart phone, a wearable device, an Internet of Things (IoT) device, a tablet, etc.

5GS networks are packet-switched (PS) Internet Protocol (IP) networks. This means that 5GS networks deliver all data traffic in IP packets, and provide users with Always-On IP Connectivity. When a UE joins an evolved packet system (EPS) network, a Packet Data Network (PDN) address (i.e., the one that can be used on the PDN) is assigned to the UE for its connection to the PDN. In 4G, EPS has defined a Default EPS Bearer to provide the IP Connectivity that is Always-On. In 5G, a PDU session establishment procedure is a parallel procedure of a PDN connection procedure in 4G. A PDU session defines the association between the UE and the data network that provides a PDU connectivity service. Each PDU session is identified by a PDU session ID, and may include multiple QoS flows and QoS rules.

Each PDU session can be established over a 3GPP RAN, or over a non-3GPP RAN for radio access. 5G session management (5GSM) for PDU sessions over both 3GPP access and non-3GPP access are managed by AMF and SMF via NAS signaling. Operators are seeking ways to balance data traffic between mobile networks and non-3GPP access in a way that is transparent to users and reduces mobile network congestion. In 5GS, UEs that can be simultaneously connected to both 3GPP access and non-3GPP access (using 3GPP NAS signalling), thus the 5GS is able to take advantage of these multiple accesses to improves the user experience, and optimize the traffic distribution across various accesses. Accordingly, 3GPP introduced MA PDU sessions in 5GS. An MA PDU session uses one 3GPP access network or one non-3GPP access network at a time, or simultaneously one 3GPP access network and one non-3GPP access network.

MA PDU sessions can be established over both 3GPP access and non-3GPP access simultaneously, or one at a time. Therefore, the user plane resources of an MA PDU session can be established on both accesses, or only on 3GPP or non-3GPP access. For established MA PDU sessions, the 5GS can initiate a PDU session release procedure to release one specific access type or both access types for the MA PDU session. However, when UE receives a PDU SESSION RELEASE COMMAND message from the network during a UE-requested MA PDU session release procedure for the same PDU session, different UE behaviors are desirable under different scenarios.

In accordance with one novel aspect, UE behaviors are proposed to handle a collision of a UE-requested MA PDU session release procedure and a network-requested MA PDU session release procedure (as depicted by 130). The collision is detected when the UE receives a PDU SESSION RELEASE COMMAND message with the PTI IE set to “No procedure transaction identity assigned” during a UE-requested PDU session release procedure, and the PDU session (ID) indicated in the PDU SESSION RELEASE COMMAND message is the same as the PDU session (ID) that the UE requests to release. If the Access type IE is included in the PDU SESSION RELEASE COMMAND message, and the PDU session is an MA PDU session and having user-plane resources established on the access different from the access indicated in the Access type IE in the PDU SESSION RELEASE COMMAND message, then the UE proceeds with both the UE-requested PDU session release procedure and network-requested PDU session release procedure (140). Otherwise, the UE aborts the UE-requested PDU session release procedure and stops the timer T3582 and proceeds with the network-requested PDU session release procedure (150).

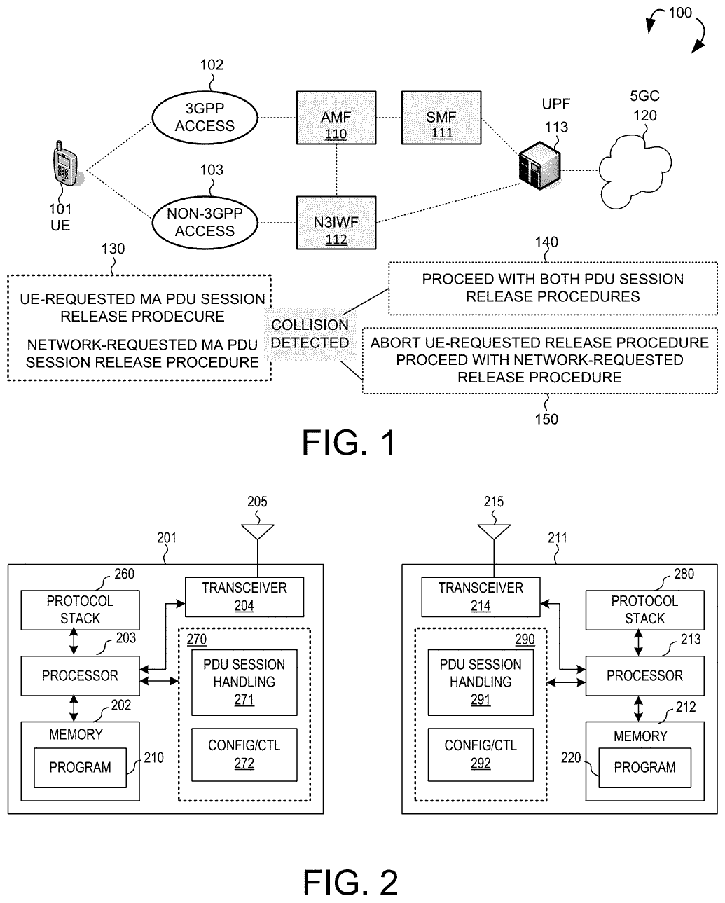

FIG. 2 illustrates simplified block diagrams of wireless devices, e.g., a UE 201 and a network entity 211 in accordance with embodiments of the current invention. Network entity 211 may be a base station and/or an AMF/SMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control function modules and circuits 290. Protocol stacks 280 includes Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. In one example, control function modules and circuits 290 includes PDU session handling circuit 291 that handles PDU establishment, modification, and release procedures, and configuration and control circuit 292 that provides different parameters to configure and control UE of related functionalities including mobility management and PDU session management.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also includes protocol stacks 260 and a set of control function modules and circuits 270. Protocol stacks 260 includes NAS layer to communicate with an AMF/SMF/MME entity connecting to the core network, RRC layer for high layer configuration and control, PDCP/RLC layer, MAC layer, and PHY layer. Control function modules and circuits 270 may be implemented and configured by software, firmware, hardware, and/or combination thereof. The control function modules and circuits, when executed by the processors via program instructions contained in the memory, interwork with each other to allow UE 201 to perform embodiments and functional tasks and features in the network.

In one example, control function modules and circuits 270 includes a PDU session handling circuit 271 that performs MA PDU session establishment, modification, and release procedures with the network, and a config and control circuit 272 that handles configuration and control parameters for mobility management and session management. Upon detecting a collision between a UE-requested MA PDU session release procedure and a network-requested MA PDU session release procedure for the same MA PDU session, UE decides whether to proceeds with both PDU session release procedures, or aborts the UE-requested PDU session release procedure and proceeds only with the network-requested PDU session release procedure.

An MA PDU session in 5GS can be established after a UE is registered to the network over both 3GPP and non-3GPP access type belonging to the same PLMN. The UE establishes a MA PDU session by initiating a PDU session establishment procedure with the network over either 3GPP or non-3GPP access type and activating the MA PDU session in a single step. The activation of the MA PDU connectivity service refers to the establishment of user-plane resources on both 3GPP access and non-3GPP access. In another embodiment, the UE is registered to the network over both 3GPP and non-3GPP access type belonging to different PLMNs. The MA PDU session is first established over one access type and then established over another access type in two separate steps. In yet another embodiment, the UE registers to the network over 3GPP access and non-3GPP access type belonging to the same PLMN and establishes the MA PDU session to the same PLMN over both 3GPP access type and non-3GPP access type in two separate steps. A MA PDU session uses one 3GPP access network or one non-3GPP access network at a time, or simultaneously one 3GPP access network and one non-3GPP access network. In addition, the UE and the network can support Access Traffic Steering Switching and Splitting (ATSSS) functionalities to distribute traffic over 3GPP access and non-3GPP access for the established MA PDU session. An MA PDU session is active when user plane resources of the MA PDU session are established over at least one access type.

For established MA PDU sessions, the 5GS can initiate a PDU session release procedure to release one specific access type or both access types for the MA PDU session. For UE-requested. PDU session release procedure, it always releases the whole MA PDU, e.g., the user plane resource over both accesses are released. For UE-requested PDU session release procedure, the SMF does not include the Access type IE in the PDU SESSION RELEASE COMMAND message. Note that for the UE-requested procedure, over which access the UE sends the PDU SESSION RELEASE REQUEST doesn't matter, and the intended result after this procedure is the whole MA PDU is released. On the other hand, for network-requested PDU session release procedure, whole MA PDU session or partial MA PDU session can be released (i.e., only releasing a single access/leg of the MA PDU). The Access type IE in the PDU SESSION RELEASE COMMAND message can indicate which access/leg of the MA PDU session is to be released, and over which access the PDU SESSION RELEASE COMMAND message is sent doesn't matter.

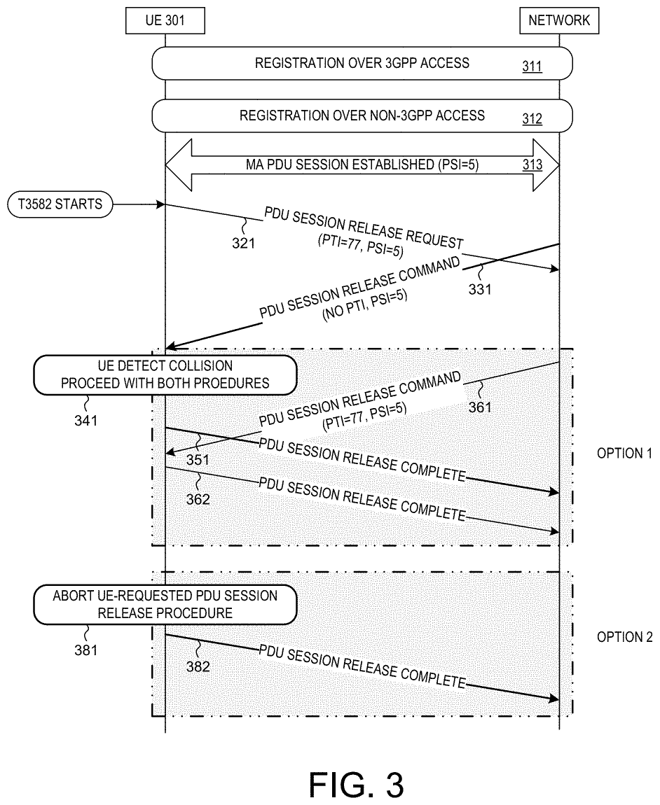

FIG. 3 illustrates one embodiment of handling collision of MA PDU session release procedures in accordance with one novel aspect. In step 311, UE 301 registers with the 5GS network over 3GPP access type. In step 312, UE 301 registers with the 5GS network over non-3GPP access type. In step 313, an MA PDU session with PSI=5 is established between UE 301 and the 5GS network, and the user plane resources can be established on both 3GPP and non-3GPP access, or only on 3GPP access, or only on non-3GPP access.

In step 321, UE 301 initiates a UE-requested PDU session release procedure, by sending a PDU SESSION RELEASE REQUEST message to the network. Note that the UE-requested PDU session release procedure is for releasing the whole MA PDU session, e.g., over both accesses/legs, regardless of over which access the UE sends the PDU SESSION RELEASE REQUEST message. In addition, the PDU SESSION RELEASE REQUEST message carries a procedure transaction ID (PTI) value (e.g., PTI=77) currently not used, and also a PSI value (e.g., PSI=5) that identifies the MA PDU session to be released. PTI is used as an identity that is allocated by the UE for the UE-requested PDU session establishment, modification, and release procedure in 5G/NR. Here, PTI=77 indicates the specific UE-requested PDU session release procedure. Upon triggering the PDU session release procedure, UE 301 starts a T3582 timer.

In step 331, UE 301 receives a PDU SESSION RELEASE COMMAND message for the same MA PDU (PSI=5), after the UE-requested PDU session release procedure is triggered, but before the procedure is completed. In step 341, UE 301 determines a collision happens between the UE-requested PDU session release procedure and the network-requested PDU session release procedure. The collision is detected when the UE receives the PDU SESSION RELEASE COMMAND message with the PTI IE set to “No procedure transaction identity assigned” during the UE-requested PDU session release procedure, and the PDU session indicated in the PDU SESSION RELEASE COMMAND message is the same as the PDU session that the UE requests to release (PSI=5). Note that because the PDU SESSION RELEASE COMMAND message carries NO PTI, the UE knows that such command is not in response to the PDU session release procedure requested by the UE, which is identified by PTI=77. The UE knows that such command is another PDU session release procedure for PSI=5 and is requested by the network.

Traditionally, upon detecting the collision between two PDU session release procedures for the same PDU session, a UE simply aborts its own procedure and proceeds with the network-requested procedure. For MA PDU, however, this does not always produce the desirable result, e.g., release the entire MA PDU session. In one novel aspect, UE 301 needs to further determine the status of the MA PDU session and the content of the PDU SESSION RELEASE COMMAND message, and then decide whether a condition is satisfied to proceed with both procedures (Option 1), or to proceed with only the network-requested procedure and aborts UE-requested procedure (Option 2).

UE 301 chooses Option 1 if the condition is satisfied under the following scenarios. In a first scenario, the PDU session is an MA PDU session and having user-plane resources established on both the 3GPP access and non-3GPP access, and the Access type IE is included in the PDU SESSION RELEASE COMMAND message, and the Access type IE indicates 3GPP access. If the UE aborts the UE-requested PDU session release procedure and only proceeds with the network-requested PDU session release procedure, then the MA PDU will not be released, and the MA PDU with non-3GPP leg will survive after the procedure. Similarly, if the Access type IE indicates Non-3GPP access, then if the UE aborts the UE-requested PDU session release procedure and only proceed with the network-requested PDU session release procedure, the MA PDU will not be released, the MA PDU with 3GPP leg will survive after the procedure.

In a second scenario, the PDU session is an MA PDU session and having user-plane resources established on only the 3GPP access, and the Access type IE is included in the PDU SESSION RELEASE COMMAND message, and the Access type IE indicates Non-3GPP access. If the UE abort the UE-requested PDU session release procedure and only proceed with the network-requested PDU session release procedure, the MA PDU will not be released, the MA PDU with 3GPP leg will survive after the procedure.

In a third scenario, the PDU session is an MA PDU session and having user-plane resources established on only the non-3GPP access, and the Access type IE is included in the PDU SESSION RELEASE COMMAND message, and the Access type IE indicates 3GPP access. If the UE abort the UE-requested PDU session release procedure and only proceed with the network-requested PDU session release procedure, the MA PDU will not be released, the MA PDU with non-3GPP leg will survive after the procedure.

Therefore, under the above three scenarios, UE 301 choose Option 1 and proceeds with both the UE-requested PDU session release procedure and network-requested PDU session release procedure. To proceed with the network-requested PDU session procedure, in step 351, UE 301 sends a PDU SESSION RELEASE COMPLETE message in response to the PDU SESSION RELEASE COMMAND message sent by the network in step 331, to complete the network-requested PDU session release procedure for the MA PDU. To proceed with the UE-requested PDU session procedure, in step 361, UE 301 receives a PDU SESSION RELEASE COMMAND message from the network, this PDU SESSION RELEASE COMMAND message carries PTI=77 and PSI=5, and thus is in response to the PDU SESSION RELEASE REQUEST message sent by the UE in step 321. In step 362, UE sends another PDU SESSION RELEASE COMPLETE message to the network, to complete the UE-requested PDU session procedure for the MA PDU. Note that the network-requested PDU release procedure may only release part of the user plane resources of the MA PDU, and the remaining user plane resources of the MA PDU will be released by the UE-requested PDU session release procedure.

To summarize, if the Access type IE is included in the PDU SESSION RELEASE COMMAND message, and the PDU session is an MA PDU session and having user-plane resources established on the access different from the access indicated in the Access type IE in the PDU SESSION RELEASE COMMAND message, then UE 301 proceeds both the UE-requested PDU session release procedure and network-requested PDU session release procedure. Otherwise, UE 301 chooses Option 2. In step 381, UE 301 aborts the UE-requested PDU session release procedure, and stops timer T3582. In step 382, UE 301 proceeds with the network-requested PDU session procedure, and sends a PDU SESSION COMPLETE message in response to the PDU SESSION RELEASE COMMAND message sent by the network in step 331, to complete the network-requested PDU session release procedure for the MA PDU. Note that it is also possible that step 382 happens before step 381.

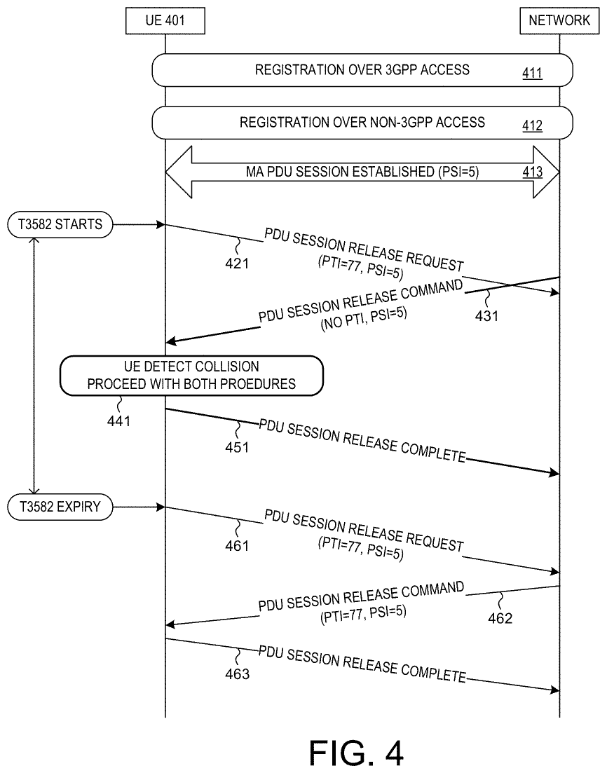

FIG. 4 illustrates another embodiment of handling collision of MA PDU session release procedures in accordance with one novel aspect. Steps 411 to 441 are similar to steps 311 to 341 of FIG. 3, where an MA PDU session having PSI=5 is established, and UE 401 detects a collision between a UE-requested PDU session procedure and a network-requested PDU session procedure for the same MA PDU session, and UE 401 decides to proceed with both procedures. To proceed with the network-requested PDU session procedure, in step 451, UE 401 sends a PDU SESSION RELEASE COMPLETE message in response to the PDU SESSION RELEASE COMMAND message sent by the network in step 431, to complete the network-requested PDU session release procedure for the MA PDU. To proceed with the UE-requested PDU session procedure, UE 401 waits for another PDU SESSION RELEASE COMMAND message, carrying PTI=77 and PSI=5. Meanwhile, timer T3582 keeps running. If UE 401 does not receive the PDU SESSION RELEASE COMMAND message upon timer expiry, then in step 461, UE 401 retransmits another PDU SESSION RELEASE REQUEST message, carrying PTI=77, PSI=5. In step 462, UE 401 receives a PDU SESSION RELEASE COMMAND message from the network, carrying PTI=77 and PSI=5. In step 463, UE 401 sends a PDU SESSION RELEASE COMPLETE message to the network to complete the UE-requested PDU session release procedure.

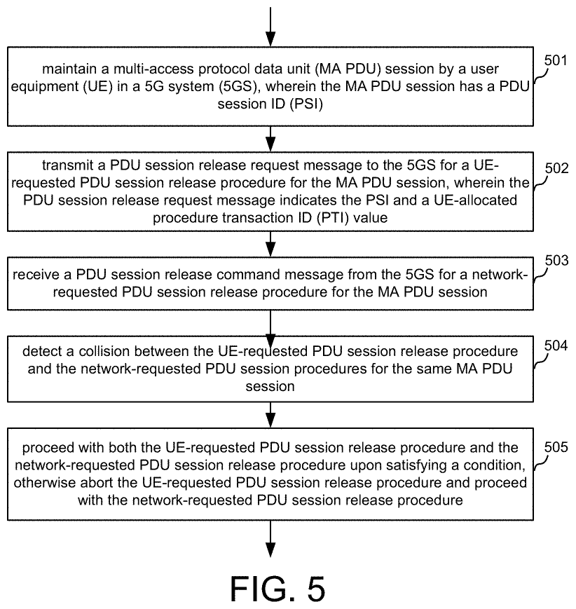

FIG. 5 is a flow chart of a method of handling collision of MA PDU session release procedures in accordance with one novel aspect of the present invention. In step 501, a UE maintains a multi-access protocol data unit (MA PDU) session in a 5G system (5GS). The MA PDU session has a PDU session ID (PSI). In step 502, the UE transmits a PDU session release request message to the 5GS for a UE-requested PDU session release procedure for the MA PDU session. The PDU session release request message indicates the PSI and a UE-allocated procedure transaction ID (PTI) value. In step 503, the UE receives a PDU session release command message from the 5GS for a network-requested PDU session release procedure for the MA PDU session. In step 504, the UE detects a collision between the UE-requested PDU session release procedure and the network-requested PDU session release procedure for the same MA PDU session. In step 505, the UE proceeds with both the UE-requested PDU session release procedure and the network-requested PDU session release procedure upon satisfying a condition, otherwise aborts the UE-requested PDU session release procedure and proceeds with the network-requested PDU session release procedure.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
maintaining a multi-access protocol data unit (MA PDU) session by a user equipment (UE) in a 5G system (5GS), wherein the MA PDU session has a PDU session ID (PSI);
transmitting a PDU session release request message to the 5GS for a UE-requested PDU session release procedure for the MA PDU session, wherein the PDU session release request message indicates the PSI and a UE-allocated procedure transaction ID (PTI) value;
receiving a PDU session release command message from the 5GS for a network-requested PDU session release procedure for the MA PDU session;
detecting a collision between the UE-requested PDU session release procedure and the network-requested PDU session release procedure for the same MA PDU session; and
proceeding with both the UE-requested PDU session release procedure and the network-requested PDU session release procedure upon satisfying a condition, otherwise aborting the UE-requested PDU session release procedure and proceeding with the network-requested PDU session release procedure.

2. The method of claim 1, wherein the collision is detected when the PDU session release command message is received during the UE-requested PDU session release procedure.

3. The method of claim 1, wherein the collision is detected when a PTI IE of the PDU session release command message is set to “No procedure transaction identity assigned”.

4. The method of claim 1, wherein the condition is satisfied when the MA PDU having user plane resources established on one access type, and wherein the Access type IE is included in the PDU session release command message and indicates another access type.

5. The method of claim 1, wherein the condition is satisfied when the MA PDU having user plane resources established on both 3GPP and non-3GPP accesses, and wherein the Access type IE is included in the PDU session release command message and indicates only 3GPP or only non-3GPP access type.

6. The method of claim 1, wherein the condition is satisfied when the MA PDU having user plane resources established on 3GPP access type, and wherein the Access type IE is included in the PDU session release command message and indicates non-3GPP access type.

7. The method of claim 1, wherein the condition is satisfied when the MA PDU having user plane resources established on non-3GPP access type, and wherein the Access type IE is included in the PDU session release command message and indicates 3GPP access type.

8. The method of claim 1, wherein the UE sends a PDU session release complete messages in response to the PDU session release command to complete the network-requested PDU session release procedure.

9. The method of claim 1, wherein the UE receives a second PDU session release command in response to the PDU session release request message.

10. The method of claim 9, wherein the UE sends a second PDU session release complete messages in response to the second PDU session release command to complete the UE-requested PDU session release procedure.

11. A User Equipment (UE), comprising:
a protocol data unit (PDU) session handling circuit that maintains a multi-access protocol data unit (MA PDU) session in a 5G system (5GS), wherein the MA PDU session has a PDU session ID (PSI);
a transmitter that transmits a PDU session release request message to the 5GS for a UE-requested PDU session release procedure for the MA PDU session, wherein the PDU session release request message indicates the PSI and a UE-allocated procedure transaction ID (PTI) value;
a receiver that receives a PDU session release command message from the 5GS for a network-requested PDU session release procedure for the MA PDU session; and
a control circuits that detects a collision between the UE-requested PDU session release procedure and the network-requested PDU session release procedure for the same MA PDU session, wherein the UE proceeds with both the UE-requested PDU session release procedure and the network-requested PDU session release procedure upon satisfying a condition, otherwise aborts the UE-requested PDU session release procedure and proceeds with the network-requested PDU session release procedure.

12. The UE of claim 11, wherein the collision is detected when the PDU session release command message is received during the UE-requested PDU session release procedure.

13. The method of claim 11, wherein the collision is detected when a PTI IE of the PDU session release command message is set to “No procedure transaction identity assigned”.

14. The UE of claim 11, wherein the condition is satisfied when the MA PDU having user plane resources established on one access type, and wherein the Access type IE is included in the PDU session release command message and indicates another access type.

15. The UE of claim 11, wherein the condition is satisfied when the MA PDU having user plane resources established on both 3GPP and non-3GPP accesses, and wherein the Access type IE is included in the PDU session release command message and indicates only 3GPP or only non-3GPP access type.

16. The UE of claim 11, wherein the condition is satisfied when the MA PDU having user plane resources established on 3GPP access type, and wherein the Access type IE is included in the PDU session release command message and indicates non-3GPP access type.

17. The UE of claim 11, wherein the condition is satisfied when the MA PDU having user plane resources established on non-3GPP access type, and wherein the Access type IE is included in the PDU session release command message and indicates 3GPP access type.

18. The UE of claim 11, wherein the UE sends a PDU session release complete messages in response to the PDU session release command to complete the network-requested PDU session release procedure.

19. The UE of claim 11, wherein the UE receives a second PDU session release command in response to the PDU session release request message.

20. The UE of claim 19, wherein the UE sends a second PDU session release complete messages in response to the second PDU session release command to complete the UE-requested PDU session release procedure.
